(19) United States
(12) Patent Application Publication
(10) Pub. No.: US 2019/0389009 A1
(43) Pub. Date: Dec. 26, 2019

(54) Method for Producing a Stamped Metal Sheet

(71) Applicant: WINK Stanzwerkzeuge GmbH & Co. KG, Neuenhaus (DE)

(72) Inventor: Albertus de Natris, Nordhorn (DE)

(21) Appl. No.: 16/489,128

(22) PCT Filed: Feb. 22, 2018
(86) PCT No.: PCT/EP2018/054344

§ 371 Date: Aug. 27, 2019

(30) Foreign Application Priority Data
Feb. 28, 2017 (DE) 10 2017 104 154.0

(51) Int. Cl. B23K 26/38; B23K 26/142; B26D 3/08; B26F 1/20; B26F 1/44

(52) U.S. Cl. CPC B23K 26/38; B23K 26/142; B26D 3/085; B26F 2001/4472; B26F 1/44; B26F 2001/4463; B26F 1/20

(57) ABSTRACT

The invention relates to a method for producing a stamped metal sheet which has at least one interrupted cutting line in (17) for producing perforations or holding points, which is arranged on a base sheet (15), characterized in that a laser beam is used for producing at least one interruption (14). The invention also relates to a stamped metal sheet.

The present invention concerns a method for producing a flexible die which comprises at least one cutting element interrupted for producing perforations or holding points, i.e., a cutting element with interruptions, that is arranged on a sheet metal base. Moreover, the invention concerns a flexible die comprising at least one cutting element interrupted for producing perforations or holding points.

Printing plants produce printed products in which perforations and holding points are present in different shapes. Examples of printed products are self-adhesive labels, admission tickets or tags as product rolls which are torn off the roll for use. In the tearing process, the labels are often torn off inclusive of the support layer or as a whole in case of single layer materials. In this context, the perforation, produced by interruptions in the stamping or cutting element of the flexible die, can be used for tearing off or for folding and bending.

In addition to such tear-off or folding perforations, also simple holding points can be produced by means of cutting elements. In case of a cut or stamped contour with holding points, the number of gaps is significantly smaller than in case of a perforation. One can also speak of a stamping element instead of a cutting element.

A partial stamping or perforation which causes weakening of the roll material is produced with, as described, with a flexible die whose cutting elements comprise interruptions. In the region of the interruptions, the roll material is not stamped. In case labels are to be torn off with support material, the perforation is designed such that the support material is also cut through. In case that, for example, a label itself is provided with a perforation that is torn when removing the label from the support web, this perforation is designed usually at the same height or depth as the cut contour of the label. The support web is then at most surficially stamped.

Often, the cuts and webs are embodied uniformly and with identical length within a perforation. The herewith associated uniform configuration of cutting element sections and interruptions of the cutting element can vary in particular in an embodiment toward the holding points. Important for the embodiment of perforations and holding points is the configuration of the cutting element interruption as well as the contour or the shape of the end faces of the cutting element facing each other.

In practice, methods for forming an interrupted cutting element by etching or engraving or grinding are known. Due to the minimal dimensions of the interruptions of the cutting elements in the range of a few tenths of a millimeter, as required, for example, for holding webs, all known methods are subject to processing insecurities.

For a good embodiment of the perforations, the interruptions are to be configured such that their depth, viewed from the uppermost stamping edge, is sufficient so as not to squeeze or damage the material to be stamped. Burrs are to be avoided as much as possible.

When etching, in the region of the unexposed regions, the steel of the flexible die is removed by the etching medium and the thickness is reduced. With progressing wash-out depth, the neighboring end faces of the cutting element pieces are however also attacked by the etching medium. The gaps become larger and the cuts smaller in length. Aside from the size of the exposed gaps, the aggressiveness of the etching medium and the etching rate to be achieved are additionally factors that are comparatively complex in regard to control and lead to nonuniform results.

Moreover, it is disadvantageous in regard to the interruption of cutting elements by etching that it is not possible to produce any desired gap. As a general rule, it holds true that the chemically producible gap in a cutting element with a satisfactory depth formation cannot become smaller than the initial steel. This means that in case of a sheet metal blank of a gap of 0.5 mm, a gap significantly smaller than 0.5 mm cannot be formed. In this context, particularly disadvantageous in connection with etching is however the weakening of the material due to cutouts that are too deep and that are to be avoided as much as possible in the region of or adjacent to the interruptions.

In engraving, ideally a straight extending engraving tool (end mill cutter) should be used which is as wide in diameter as the gap to be produced. In this way, the gaps can be produced in one pass and one would select the feed of the tool length such that the depth configuration of the gap is optimal and flush with the surface of the sheet metal base.

Due to the demands in regard to most of the gaps with widths between 0.1 and 1 mm, such engraving tools are however too unstable and break off due to the occurring pressure and shearing forces. Instead, tools are used that taper to a tip and are additionally also beveled at the tip in order to stabilize them. The conicity is however disadvantageous for a penetration depth to be achieved across the entire width of the interruption of the cutting element of the flexible die. The interruption is wider at the upper end at the level of the cutting edge than at the bottom.

A problem is furthermore the high load on the engraving tool. Often, the tool breaks during the engraving process in which pre-programmed paths are followed, or it is subject to great wear. In the most serious case, both are not detected by the manufacturer, and this leads in the end to interruptions of the flexible die that are different and in particular are not deep enough and damage the material to be stamped to the point of bursting. The interruptions thus cannot be produced with precise fit in regard to depth as well as in regard to width/length.

Similar problems due to non-uniform wear of the tool also result in the grinding process in which a tool disk is rotating about an axis which is parallel to an areal extension of the sheet metal base. In particular in case of narrow interruptions, the disks wear quickly which is often not noticed.

It is object of the present invention to produce interruptions of cutting elements on flexible dies in a process-reliable way with regard to the stamping result.

The object is solved by a method according to claim 1 as well as by an article according to claim 13. Further advantages and details of the invention can be taken from the following description as well as the dependent claims.

According to the invention, a laser beam is used for producing the at least one interruption of the cutting element. The disadvantages associated with a laser beam of a penetration too deep into the flexible die are accepted knowingly and contrary to conventional opinion and are compensated surprisingly by the advantages associated with using a laser beam.

No sharp burrs are produced due to the elimination of mechanical deformation or interruption of the cutting element by means of material-removing cutting tools. The flanks of the cutouts due to the straight laser beam can be produced very straight. The weakening of the sheet metal base associated with a possible penetration of the laser beam is accepted knowingly. The laser does not wear like mechanical tools when producing the interruption so that a more uniform configuration of the interruptions and thus a significantly higher process reliability is achieved.

Laser beams are understood as electromagnetic waves which comprises in a preferably narrow frequency range a sharply focused beam and a large coherence length. In particular, it is monochromatic light and/or beam pulses of a defined and material-depending adjustable repeating frequency.

In particular, the interruption is completely produced by the laser beam, i.e., a rudimentary preparation of the interruptions by etching or e.g. engraving is not carried out so that the energy quantity to be provided by a laser beam must be increased but the process insecurity associated with the conventional processing methods is avoided.

In particular, the cutting element is thus initially embodied completely uninterrupted and thus continuously formed and interrupted only once it is produced. In this respect, the introduction of the laser beam is a working step that can be separately integrated into the process sequence for producing a flexible die and that can be performed after producing the cutting element. In particular, the cutting element, after producing the interruption, can still be sharpened in its remaining sections when a prior formation of the cutting element was carried out initially without sharpening or sharpening is to be performed later.

Energy, residence duration, and focusing of the laser beam are preferably even chosen such that upon producing the interruption a cutout is produced down into the sheet metal base. The weakening of the sheet metal base and a possibly associated stability are accepted knowingly in order to ensure a higher process reliability.

Particularly preferred, the sheet metal base is completely cut through by the laser beam when forming the interruption. In doing so, the flexible die is maximally weakened, but a process control due to the then resulting gap in the cutout can be performed significantly more easily. By introducing the energy in the form of laser light, a melt bath is produced, but in particular the energy of the laser beam as well as optionally furthermore the pressure and a flow rate of a protective gas are preferably to be chosen such that the material is cut away or blown away. The surrounding regions of the interruption in the sheet metal base or in the stamping element are minimally affected or damaged in this way.

The depth of the cutout, due to its passing all the way through the sheet metal base, is maximal so that in the stamping process for producing the perforation or holding points no impairment of the material to be stamped is realized.

A simple passage inspection for monitoring the obtained result by means of an inspection whether the introduced interruptions of the cutting element indeed pass all the way through the flexible die, e.g. in the form of a look-through inspection, enables a quick and efficient control of the flexible die without the product to be stamped having to be torn for taking a sample. This inspection can be done already upon introduction of the interruption and, when determining a laser energy that is too low, the latter can be readjusted. It can be performed alternatively or as a supplement also after producing the interruption. An inspection of the flexible die according to the old prior art, in which the interruptions without adjoining cutouts were measured, was significantly more complex and therefore was frequently not performed.

Processing in the form of cutting out or cutting to size a cutting element with a laser beam has been considered in the past as inconceivable, in particular due to the reduced flexible die thickness optimized over the years. In this respect, processing of flexible dies within the flexible die pattern region and in particular the cutting elements has not been provided for up to now.

In particular, the laser beam energy applied in the region of the cutout to be produced to the flexible die, the pressure and/or the flow rate of the protective gas is to be chosen such that the flexible die material which is impacted by the laser beam is removed without any residue. Preferably, a 99.999% nitrogen atmosphere is formed as a protective gas atmosphere. A protective gas nozzle which is used in this context blows away with its protective gas jet at a pressure of preferably at least 6 bar, in particular between 7 and 10 bar, the material which is impacted by the laser beam so that it is removed from the flexible die without leaving a residue.

Advantageously, the laser beam for producing the interruption is moved perpendicular to the uppermost cutting edge of the cutting element, i.e., the cut performed by the laser beam is carried out at a right angle to the longitudinal direction of the cutting element along the surface of the sheet metal base. This leads to a flank or end face of the cutting element which, at the side facing the interruption, looks like a cutting element geometry produced by engraving technology.

According to a further embodiment of the invention, a laser beam with a focal point that has a diameter of 0.12 mm is used for producing the interruption. With a laser beam embodied in this way, in particular focused, the interruptions, required currently and foreseeably, can be produced in a good way.

The production of an interruption becomes particularly economical when, for interruptions of a length of more than 0.25 mm, flexible die sections are cut out by circumscribing with the laser beam. Instead of moving through the thicker construction of the cutting element several times, which would be possible otherwise, the laser beam ideally circumscribes a geometric figure, for example, a small rectangle or a circular segment section in cutting element curves and the material that is circumscribed is cut out. In this context, the laser beam can move already in the region of the sheet metal base adjoining the not yet interrupted cutting element. Alternatively, exactly the tapering region of the cutting element contour is moved across so that the structure of the sheet metal base outside of the cutting elements is not unnecessarily weakened more.

In particular, the end face of the cutting element which is facing the interruption and/or a sheet metal base region adjoining the interruption is produced at the bottom side and/or at the top side without a burr and/or without a bead.

The aforementioned object is also solved by a flexible die which at least comprises a cutting element interrupted for producing perforations or holding points wherein the flexible die comprises an interruption produced by laser between end faces of the cutting element which are facing each other. In particular, such a flexible die is produced by the afore described method, or method described in the following, according to the invention. Correspondingly, such a flexible die also comprises the afore described advantages or advantages described in the following.

In particular, the interruption is continuously embodied, i.e., the interruption adjoins a cutout in the sheet metal base wherein the cutout passes all the way through the sheet metal base. The interruption passes into the cutout of the sheet metal base. The cutting element interruption is sufficient in regard to depth. Even during the material compression which is caused during stamping, the material to be stamped is pushed into the created interruption or cutout and remains undamaged. Preferably, the edges of the cutout relative to the sheet metal base can be rounded slightly by a laser beam provided with reduced energy introduction so that effects on the material to be processed can be substantially avoided.

Further advantages and details of the invention can be taken from the following figure description. It is schematically illustrated in

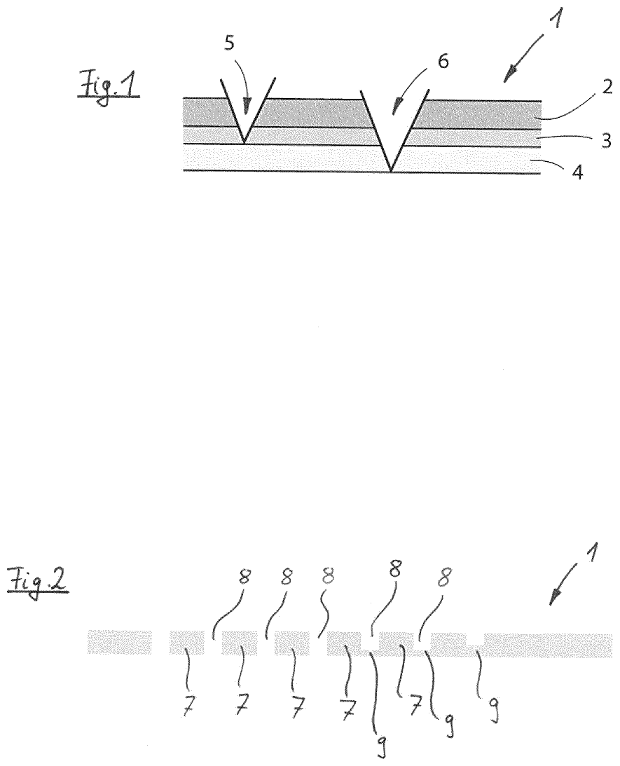

FIG. 1 a cross-section of a multi-layer material that has been surficially stamped and stamped through;

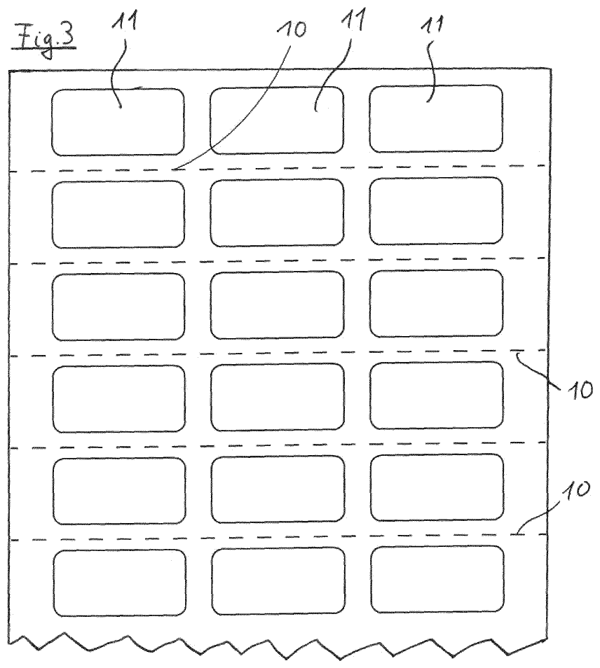

FIG. 2 the result of a perforation stamping;

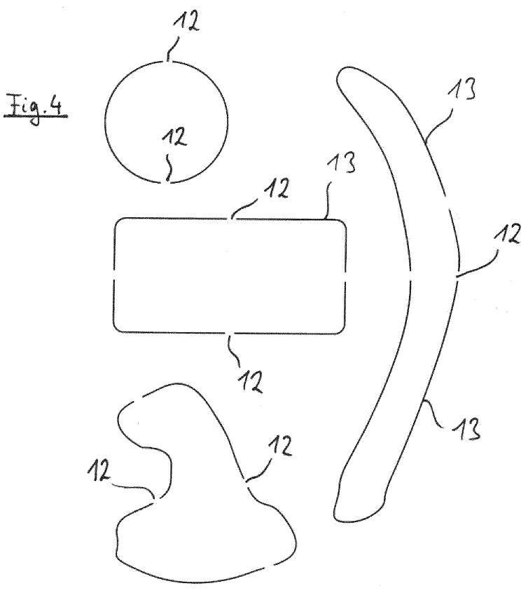

FIG. 3 a web of labels with perforation lines;

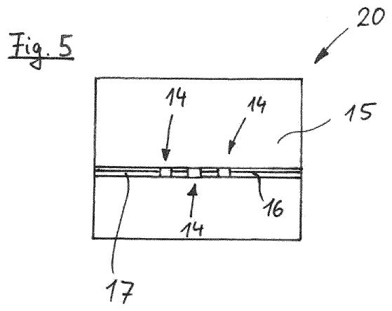

FIG. 4 a result of a method according to the invention in the form of cut contours with holding points in a plan view;

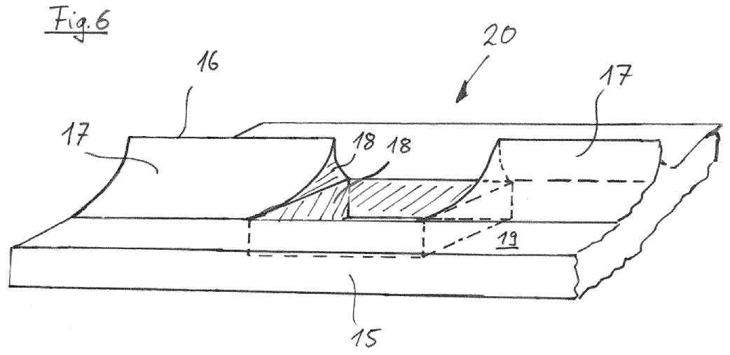

FIG. 5 a plan view of a part of a flexible die according to the invention;

FIG. 6 a perspective view of a part of a further flexible die according to the invention.

Individual technical features of the embodiments described in the following can also be combined in combination with afore described embodiments as well as the features of the independent claims and possible further claims to subject matter according to the invention. Inasmuch as expedient, elements that act functionally in the same way are provided with identical reference numbers.

In FIG. 1, the result of stamping through and surficially stamping of a multi-layer material 1 is illustrated in general. In the cut 5 produced by surficial stamping as well as in the cut 6 produced by stamping through, the top material 2 has been cut through in the region of the cutting element of the flexible die. Also, the adhesive layer 3 in both variants is cut through. The support material 4, on the other hand, is cut through only by stamping through (cut 6).

The stamping material 1 illustrated in FIG. 2 shows a cross section of a perforation line with approximately same-length material sections 7 which are interrupted in a regular pattern by the stamped-through regions 8. In case the interruptions of the cutting element required for the sections 7 are not embodied deep enough, the material to be processed is squeezed in the region of the interruption according to the old prior art. This, in particular in combination with already worn stamping elements, can lead to a complete separation of the material no longer taking place and to material webs 9 remaining which impair tearing off a label along the perforation line.

Perforation lines 10 serve, for example, for tearing off label strips in groups with e.g. three labels 11 from a roll of material, as in the embodiment according to FIG. 3.

In place of perforation lines, also holding points 12, illustrated in FIG. 4, can be embodied as interruptions of the stamped lines 13. The holding points 12, like the material sections 7, are also produced as material sections by interruptions of a cutting or stamping element 13 of a flexible die. The corresponding flexible die is produced by a method according to the invention.

Correspondingly, a flexible die of which a detail is illustrated in FIG. 5 comprises a cutting element 17 that is provided with a total of three interruptions 14. The cutouts 14 are continuous and represent thus cutouts that can be easily inspected by a passage inspection. This can be done in the context of a visual look-through inspection, either automatically by a light beam which is detected by a photosensor on the other side of the flexible die. In the simplest case, this inspection can be performed by operating personnel who inspect the machined flexible die in front of a backlighting source.

The interruptions 14 according to FIG. 5 are embodied across the entire width of the stamping element 17. They adjoin in this context regions of a sheet metal base 15 of the flexible die 20 that are not raised anymore.

The laser beam has produced in the sheet metal base 15 cutouts or openings that are passing all the way through. The rectangular regions illustrated in FIG. 5 have been produced by moving along a laser beam, not illustrated and positioned perpendicular to the figure plane, along a rectangular contour wherein the laser beam has been moved orthogonally to the cutting edge 16 of the cutting element 17 for producing a smooth end face.

FIG. 6 shows in a perspective view a further detail of the flexible die 20 according to the invention. An end face 18 of the cutting element has been embodied smooth and straight by the laser beam oriented orthogonally to the surface 19 of the sheet metal base 15. The interruption of the cutting element 17 continues in a cutout with edges that are illustrated by interrupted lines, which is embodied so as to pass all the way through the sheet metal base 15.

What is claimed is:

1.-14. (canceled)

15. A method for producing a flexible die, which comprises at least one cutting element interrupted for producing perforations or holding points and arranged on a sheet metal base, the method comprising the step of producing at least one interruption by a laser beam in the at least one cutting element.

16. The method according to claim 15, wherein the at least one interruption is produced completely by the laser beam.

17. The method according to claim 15, further comprising providing the at least one cutting element as an uninterrupted cutting element on the sheet metal base and carrying out the step of producing the at least one interruption by the laser beam in the uninterrupted cutting element.

18. The method according to claim 15, further comprising producing a cutout in the sheet metal base when carrying out the step of producing the at least one interruption by the laser beam.

19. The method according to claim 18, wherein the laser beam cuts through the sheet metal base to form the cutout.

20. The method according to claim 19, further comprising the step of carrying out a passage inspection for monitoring the flexible die after and/or during the step of producing the at least one interruption by the laser beam.

21. The method according to claim 20, wherein the passage inspection is a look-through inspection.

22. The method according to claim 15, the step of producing the at least one interruption by the laser beam including choosing a laser beam energy and choosing a pressure and/or a flow rate of a protective gas such that a flexible die material impacted by the laser beam is removed without any residue.

23. The method according to claim 22, the step of producing the at least one interruption by the laser beam further including blowing off the flexible die material impacted by the laser beam by a protective gas jet of the protective gas.

24. The method according to claim 15, the step of producing the at least one interruption by the laser beam including moving the laser beam perpendicular to the at least one cutting element.

25. The method according to claim 15, wherein the laser beam has a focal point of a diameter of 0.12 mm.

26. The method according to claim 15, the step of producing the at least one interruption by the laser beam including cutting out flexible die sections by circumscribing the flexible die sections by the laser beam to produce the at least one interruption with a length of more than 0.25 mm.

27. The method according to claim 15, wherein an end face of the at least one cutting element facing the at least one interruption is produced without a burr and/or without a bead.

28. The method according to claim 15, wherein a sheet metal base region adjoining the at least one interruption is produced without a burr and/or without a bead.

29. The method according to claim 15, wherein an end face of the at least one cutting element facing the at least one interruption is produced without a burr and/or without a bead and wherein a sheet metal base region adjoining the at least one interruption is produced without a burr and/or without a bead.

30. A flexible die, comprising a sheet metal base and at least one cutting element interrupted for producing perforations or holding points and arranged on the sheet metal base, wherein the at least one cutting element comprises an interruption produced by laser between end faces of the at least one cutting element that are facing each other.

31. The flexible die according to claim 30, wherein the interruption adjoins a cutout in the sheet metal base, wherein the cutout passes all the way through the sheet metal base.
